(19) United States
(12) Patent Application Publication
(10) Pub. No.: US 2022/0292980 A1
(43) Pub. Date: Sep. 15, 2022

(54) METHOD AND SYSTEM FOR ORGANIZING SERVICE PROVIDER INFORMATION FOR AUTO DISPATCH SERVICE

(71) Applicant: Tivadar Bodorlo, Delray Beach, FL (US)

(72) Inventor: Tivadar Bodorlo, Delray Beach, FL (US)

(21) Appl. No.: 17/691,782

(22) Filed: Mar. 10, 2022

Related U.S. Application Data
(60) Provisional application No. 63/159,190, filed on Mar. 10, 2021.

(51) Int. Cl. G08G 1/00; G06F 16/9535; G06F 16/9537

(52) U.S. Cl. CPC G08G 1/205; G08G 1/202; G06F 16/9535; G06F 16/9537

(57) ABSTRACT

A method and system for organizing service provider information for auto dispatch service includes maintaining a presence records for each of a plurality of service providers and sub-accounts, if any, for each of the service providers. The presence records indicate service providers that are presently available to respond to customer service requests. The system organizes the presence records by service category, and each service record include location information of the service provider that can be updated periodically. Upon receiving a request for service from a user, the system compares the type of service being requested with the categories of presence lists, and then searches for service providers on that presence list by presence record to identify one or more service providers near the requester who can timely respond to the request. The system can then initiate a communication between the service requester and one of the service providers.

### CROSS REFERENCE

This application claims priority to provisional application No. 63/159,190, filed Mar. 10, 2021, the entirety of which is hereby incorporated by reference.

### FIELD OF THE INVENTION

The present invention relates generally to directory systems to find service providers, and, more particularly, relates to a system that allows a user to make a simple request for a given service that is processed to identify and message an available service provider who can contact the user in a very short time.

### BACKGROUND OF THE INVENTION

The ability to find a service provider has greatly improved from the days when a person had to use a printed phone directory to look up service providers by category, call one or more service providers, explain to the service provider over the phone what service they required, and then arrange for the service provider to come to the person's location. Today internet search engines make this a faster process. There are even websites, such as, for example ANGIESLIEST.COM, that cater to people seeking service from service providers. In general, such internet sites amount to directories that require a person to search through to find a service provide who is near to them, and then to use the contact information to contact the service provider, talk to the service provider, and see if they would like to have the service provider come to their location. These modes of finding service providers still require the user to spend time searching a looking through listings, or at least providing a detailed description of the issue for which they need service.

Therefore, a need exists to overcome the problems with the prior art as discussed above.

### SUMMARY

In accordance with some embodiment of the inventive disclosure, there is provided a method for providing instant service that includes establishing a user account and a service provider account at a datacenter. The user account indicating a location of the user, and the service provider account indicating a type of service provided by the service provider and a location of the service provider. The method further includes creating, by the datacenter, a plurality of presence lists, each one of the presence lists for a particular category of service, and indicating at least one service provider that is presently available and a location of the at least one service provider. The method further includes receiving, at the datacenter, a request from the user for a service, the request including an indication of a category of the service required by the user. The method further includes the datacenter, in response to the request, identifying the category of service required by the user, and searching one of the plurality of presence lists corresponding to the service required by the user to identify at least one service provider having a location within a minimum location distance from the location of the user. The method also includes the datacenter, after identifying the at least one service provider, transmitting a message to the service provider including information about the user. The method further includes receiving, at the datacenter, from the at least one service provider, confirmation that the service provider is available, the service provider contacting the user.

In accordance with a further feature, establishing the service provider account further includes verifying a license of the service provider.

In accordance with a further feature, establishing the service provider account includes establishing a plurality of sub-accounts for each of a plurality of employees of the service provider, wherein each of the sub-accounts are maintained separately on the corresponding one of the plurality of presence lists such that a location for each one of the sub-accounts can be updated separately.

In accordance with a further feature, the method further includes the service provider periodically transmitting location information to the datacenter that the datacenter uses to update a presence record corresponding to the service provider.

In accordance with a further feature, responsive to receiving confirmation, the datacenter initiates a call between the service provider and the user.

In accordance with some embodiment of the inventive disclosure, there is provided a computer implemented method for matching a service request with a service provider including maintaining, at a server, for each of a plurality of service providers, a respective service provider record, the service provider record indicating, for the corresponding service provider, a category of service provided, contact information for the service provider, a service location that defines a geographic region, and a present availability. The method further includes maintaining, at the server, a plurality of presence lists, where each one of the plurality of presence lists corresponds to the category of service and including at least one service provider presence record indicating that the respective service provider corresponding to the at least one service provider presence record is presently available. The method further includes receiving, at the server, for each of the at least one service provider presence records, periodic location updates for the respective service provider. The method further includes receiving, at the server, a service request from a user including an indication of a category of service being requested. The method further includes the server identifying one of the plurality of presence lists corresponding to the category of service being requested, and comparing a user location of the user with the locations of each of at least one service provider presence record in the one of the plurality of presence lists and identifying a candidate service provider. The method further includes initiating a communication between the candidate service provider and the user.

In accordance with a further feature, initiating communication between the candidate service provider and the user comprises transmitting to the candidate service provider the contact information of the user.

In accordance with a further feature, initiating communication between the candidate service provider and the user comprises initiating a call between the candidate service provider and the user.

In accordance with a further feature, after identifying the candidate service provider, the server transmits a message to the user including information about the candidate service provider; and

the server receiving confirmation from the user to proceed.

In accordance with a further feature, identifying the candidate service provider comprises identifying a plurality of candidate service providers, and receiving a selection of one of the plurality of candidates from the user.

In accordance with some embodiment of the inventive disclosure, there is provided a system for matching a service request with a service provider including a server having a processor, and wherein the processor executes instruction code that causes the processor to maintain, at the server, for each of a plurality of service providers, a respective service provider record, the service provider record indicates, for the corresponding service provider, a category of service provided and contact information for the service provider, a service location that defines a geographic region, and a present availability. The processor is further operable to maintain, at the server, a plurality of presence lists, each one of the plurality of presence lists that corresponds to the category of service and includes at least one service provider presence record that indicates that the respective service provider corresponding to the at least one service provider presence record is presently available. The processor is further operable to receive, at the server, for each of the at least one service provider presence records, periodic location updates for the respective service provider. The processor is further operable to receive, at the server, a service request from a user including an indication of a category of service being requested. The processor is further operable to identify, by the server, one of the plurality of presence lists corresponding to the category of service being requested, and comparing a user location of the user with the locations of each of at least one service provider presence record in the one of the plurality of presence lists and identifying a candidate service provider. The processor is further operable to initiate a communication between the candidate service provider and the user.

In accordance with a further feature, the server, to initiate communication between the candidate service provider and the user, transmits to the candidate service provider the contact information of the user.

In accordance with a further feature, the server, to initiate communication between the candidate service provider and the user, initiates a call between the candidate service provider and the user.

In accordance with a further feature, the processor further in response to identifying the candidate service provider, transmits a message to the user including information about the candidate service provider, and the server receives confirmation from the user to proceed.

In accordance with a further feature, the processor, in identifying the candidate service provider, identifies a plurality of candidate service providers, and receives a selection of one of the plurality of candidates from the user.

Although the invention is illustrated and described herein as embodied in an instant service provider system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. To the extent that the inventive disclosure relies on or uses software or computer implemented embodiments, the terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a chart diagram of the overall operation of an instant service provider system, in accordance with some embodiments;

FIG. 2 is a system diagram of an instant service provider system, in accordance with some embodiments;

FIG. 3 is a flow chart diagram of a method for instant service provider locating, in accordance with some embodiments; and

FIG. 4 is a process diagram of a method for providing instant service, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

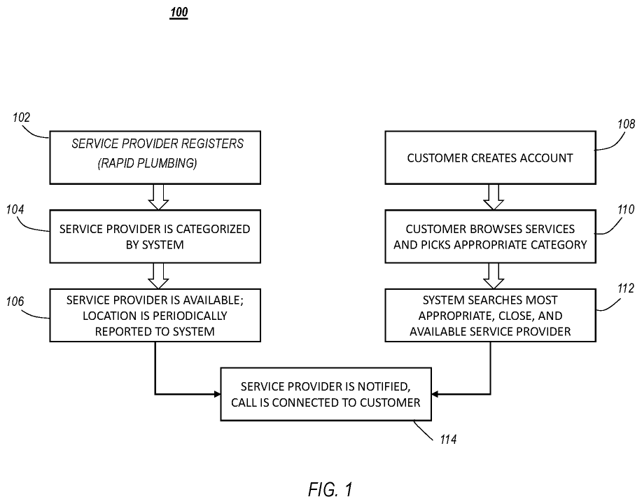

FIG. 1 is a chart diagram of the overall operation of an instant service provider system 100, in accordance with some embodiments. Starting in the upper left box 102, a service provider registers with the system by providing certain information about their services. The system can, for example, provide a form to allow the service provider to select general categories of service, and they allow the service provider to provide more detailed information as well. An administrator can verify the information provided, including licenses that are required to perform work for the services provided by the service provider. In the middle left box 104, the information provided by the service provider is categorized into any of several categories and subcategories at the datacenter of the system. The datacenter includes computing equipment and resources, including, for example, servers, databases, storage, processing hardware, memory, and software. To increase efficiency, separate records can be made for the service provider in each category of service they provide. Thus, if a plumber does interior plumbing, as well as, for example, sprinkler system installation, septic tank service, and so on, each of these can be different categories of service, and the service provider can have a separate record for each category. This simplifies the record format for searching. In the lower left box 106 the location of the service provider is determined, which is also included in each record for the service provider in the different categories. Further, the location information can include a fixed location that can be a main facility or other fixed location, as and a live location that can be obtained periodically from one or more cell phones carried by workers or employees of the service provider. The location can be a point location, such as an address, or it can be a geofenced region in which the service provider is willing to operate, or an area around the service provider at a given time. The live location information can be provided by the satellite location receiver on the service provider's cell phone, and updated at the system datacenter periodically.

At the top right box 108, a user likewise registers with the system by use of an application program or web page interface. The user can be given the option of connecting an internet appliance to the system. Examples of internet appliances include, for example, the ECHO and ALEXA devices sold by Amazon, Inc. These devices can be voice controlled to recognize spoken commands, and then access resources via the Internet, as required. After the user sets up their account in the top right box 108, then the device(s) can be provisioned to interact with the system's datacenter. In box 110 the user begins a service request by picking an appropriate service category. The selection of service category can be done on a touch screen, such as on a phone device running an application program for the service, or selected using a mouse in a browser window, or recognized when spoken to an internet appliance that has voice recognition capability In box 112 the request is processed by the datacenter to find a suitable service provider. This is done without the user having to search for a provider. For example, the user can simply speak “I need a plumber,” and the software on the user's device recognizes this as a command to format a request and send the request to the datacenter for processing. The request will identify the user or otherwise include a user identifier that the datacenter can cross reference to obtain the user's location and contact information, or the location can be included in the request as either that of an address or a set of geo coordinates produced by the satellite positioning receiver on the user's phone. Other types of location detection can likewise be used, such as network address mapping. In processing the request (still in box 112), the datacenter can respond to the request by sending information about a service provider in the area, giving the user the opportunity to accept or reject the service provider, or alternatively, the user can indicate that they simply want to be connected to a service provider immediately. If the user rejects the service provider, an alternative service provider can be selected and the process repeated until, in box 112, the user has accepted a service provider. In box 114, the user's information can be provided to a the selected service provider who can contact the user to obtain any necessary details or further information that may be necessary for the service provider to respond or to indicate an approximate time when the service provider may arrive at the user's location. The user can be provided with tracking updates at periodic intervals to have an idea as to when the service provider will arrive. In some embodiments the system can pass the user's phone number straight to the service provider's mobile device through an application program that, in turn, passes the user's phone number to a messaging application program or a phone program so that the service provider can simply respond to the user by message or calling them.

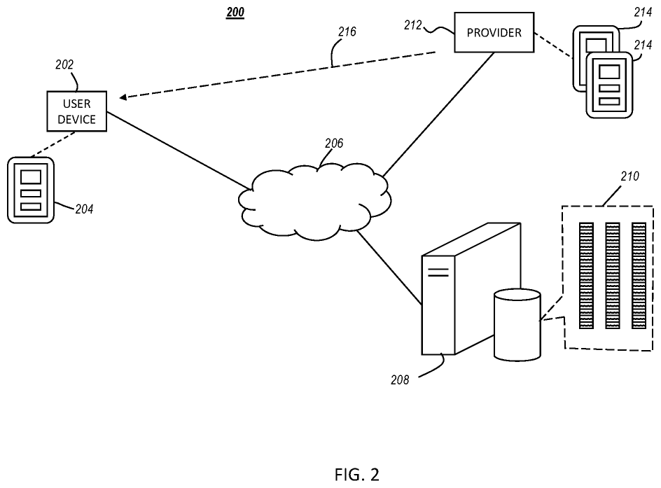

FIG. 2 is a system diagram of an instant service provider system 200, in accordance with some embodiments. In accordance with FIG. 1, generally, a user can use a user device 202 such as, for example, a mobile device 204 (e.g. cellular phone) to set up and operate an account with an instant service provider system datacenter 208 over the internet 206. In general, the user device 202 provides a computing environment that can run application programs, and can connect to a network. The user device 202 provide further services, such as, for example, a location service using a satellite positioning receiver (e.g. Global Positioning System), and provides an interactive interface that allows the user to enter information, initially, and then to request and screen service providers later, when they need a service provider. Alternatively, the device 202 can come already provisioned to work with the data center after the user provides some information to the device 202. For example, an internet appliance can be bought by the user through a company with which the user has an account, and the internet appliance can be pre-provisioned with the user's information. Similarly, service providers such as service provider 212 can set up an account with the datacenter 208 by providing their information, including location, services provided, location, and contact information. The service provider 212 can have multiple devices 214, each provided to a different one of a plurality of employees of the service provider 212. Each of the devices 214 can be separately tracked by the datacenter 208 by the service provider devices 214 periodically transmitting their present location to the datacenter server 208. This allows the service provider 212 to cover more region as employees are sent out on jobs to various locations. In some embodiments, the datacenter 208 can contact individual devices 214 directly in response to a service request from a user 202, or the datacenter 208 can contact a dispatcher of the service provider 212, based on the locations of the service provider devices 214. For example, if one of the service provider devices 214 is near user 202, the datacenter can contact the dispatcher of the service provider 212 who can then contact the user 202 and coordinate a possible service call by either dispatching the nearest one of the employees after they have finished a present task/job, or send another employee who can respond sooner.

When the user 202 requires a service, they can activate their device 204 to commence a service request process. The service request process involves the device 204 contacting the datacenter 208 to set up a communication session in which a request message is transmitted to the datacenter 208. The datacenter 208 can maintain presence lists 210 of various service provider categories for various regions. Service providers can provide real time location updates that are reflected in their presence record. Thus, presence lists 210 indicate which service providers are currently available, the category of service they provide, and their present locations. This can be accomplished in many ways including the service provider simply providing hours of operation, or a software application at the service provider's device that periodically assures (handshakes) the datacenter 208 to that it is available and reports a present location.

The datacenter 208 processes the request by identifying the type of service being requested and the requester's location, and comparing that information to the available service providers, by service category and location of service providers. The datacenter 208 can identify one or more service providers who meet the user's criteria, and then request the user's approval by sending details of the service provider to the user's device for approval, and then contacting the service provider once the user approves the proposed service provider. Alternatively, the datacenter can set up a call between the selected service provider and the user, and facilitate communications between the service provider and the user using, for example, a voice over IP (VoIP) channel, or the service provider can contact the user directly, as indicated by arrow 216.

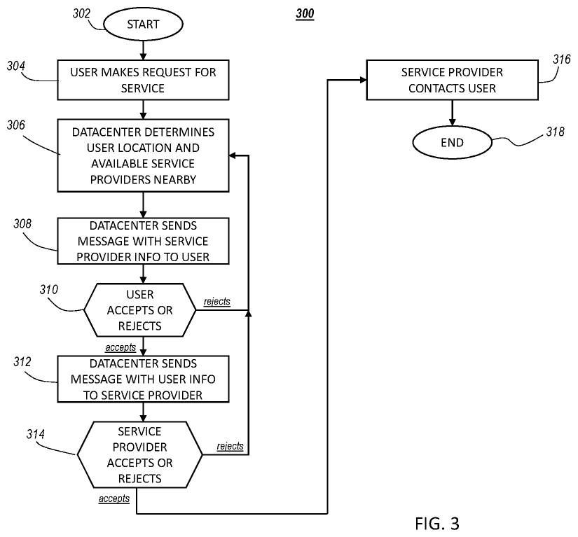

FIG. 3 is a flow chart diagram of a method 300 for instant service provider locating, in accordance with some embodiments. The method 300 starts 302 with the user and service provider accounts set up and their equipment initialized. In step 304 the user can make a service request, which is routed to the datacenter. In step 306 the datacenter determines the type of service needed, the user location, and an available service provider for that location and type of service. In step 308 the datacenter can send information about the service provider to the user. The information can include information provided by the service provider to the datacenter, as well as third party information (e.g. reviews). In step 310 the user can either accept or reject the service provider. If the user accepts the service provider, then in step 312 the datacenter sends the user information to the service provider. In step 314 the service provider can accept or reject the opportunity. If the service provider accepts the opportunity, then the service provider contacts the user in step 316, either directly or through a channel facilitated by the datacenter. Then the user can wait for the service provider to arrive, and the datacenter can periodically provide updates to the user as to the location/progress of the service provider in traveling to the user's location. Then the method can end 318. In steps 310, 314 if either party indicates a rejection, then the method returns to step 306.

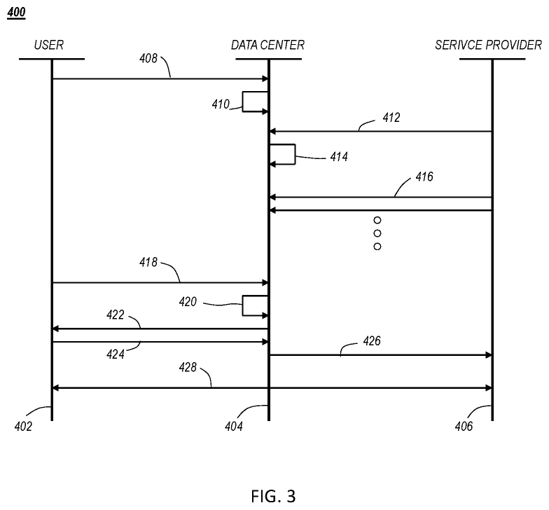

FIG. 4 shows a process diagram of a method 400 for providing instant service, in accordance with some embodiments. The method 400 largely follows that of the flow chart in FIG. 3. A user 402, datacenter 404, and service provider 406 are represented. Time passes from the top of each vertical line representing these entities as the lines are traversed downward. A user 402 can initiate establishing an account represented by line 408, in which the user's contact information and other information for establishing the account is transmitted to the datacenter through an account creation interface. Once all the necessary information is obtained, the datacenter 404 creates the account 410. Similarly, the service provider 406 can create an account by providing information 412 to the datacenter 404. The datacenter 404 can then verify any information that needs to be verified (e.g. licensing) and create a service provider account 414, which will also link to the process for maintaining presence lists. Subsequently, the service provider's equipment (e.g. mobile device) can periodically transmit current location information 416 to the datacenter 404 which the datacenter 404 will use to update its presence list.

At some time the user 402 may require service, and operate their equipment to send a service request 418 to the datacenter 404. The datacenter 404 will then process 420 the request by identifying the category of service needed, and then searching a presence list for that category by location to find the closest service providers. The datacenter 404 can then return 422 brief descriptions of one or more service providers who best match the user's request. The user 402 can then select 424 one of the service providers, an in response the datacenter can alert 426 the selected service provider 406, which can include a request to confirm the service provider is willing to contact the user. The datacenter 404 can then forward the user information to the service provider, who can then call or contact 428 the user. Alternatively, the datacenter 404 can simply determine the best match of available service providers, and initiate communication between the service provider and the user by pushing a phone number to the service provider's equipment, and causing the service provider's device to call the user 402. In a further alternative, in response to the service provider confirming availability, the datacenter can pass contact information to a call processor that initiates a call to both the service provider and the user.

An instant service provider system has been disclosed that allows a person to quickly be contacted with the service provider who can provide a type of service the person wish to have provided. The system can be accessed in several ways, including in-home internet appliances and mobile devices. A voice interface can receive a person's request and send it to a datacenter for processing. The data center maintains a presence list of various service providers, based on service field and location, and identifies an available service provider. The datacenter then transmits or causes a message to be transmitted to the identified service provider who then contacts the user.

What is claimed is:

1. A method for providing instant service, comprising:
establishing a user account and a service provider account at a datacenter, the user account indicating a location of the user, and the service provider account indicating a type of service provided by the service provider and a location of the service provider;
creating, by the datacenter, a plurality of presence lists, each one of the presence lists for a particular category of service, and indicating at least one service provider that is presently available and a location of the at least one service provider;
receiving, at the datacenter, a request from the user for a service, the request including an indication of a category of the service required by the user;
the datacenter, in response to the request, identifying the category of service required by the user, and searching one of the plurality of presence lists corresponding to the service required by the user to identify at least one service provider having a location within a minimum location distance from the location of the user;
the datacenter, after identifying the at least one service provider, transmitting a message to the service provider including information about the user;
receiving, at the datacenter, from the at least one service provider, confirmation that the service provider is available; and
the service provider contacting the user.

2. The method of claim 1, wherein establishing the service provider account further include verifying a license of the service provider.

3. The method of claim 1, wherein establishing the service provider account includes establishing a plurality of sub-accounts for each of a plurality of employees of the service provider, wherein each of the sub-accounts are maintained separately on the corresponding one of the plurality of presence lists such that a location for each one of the sub-accounts can be updated separately.

4. The method of claim 1, further comprising, the service provider periodically transmitting location information to the datacenter that the datacenter uses to update a presence record corresponding to the service provider.

5. The method of claim 1, further comprising, responsive to receiving confirmation, the datacenter initiating a call between the service provider and the user.

6. A computer implemented method for matching a service request with a service provider, comprising:
maintaining, at a server, for each of a plurality of service providers, a respective service provider record, the service provider record indicating, for the corresponding service provider, a category of service provided, contact information for the service provider, a service location that defines a geographic region, and a present availability;
maintaining, at the server, a plurality of presence lists, each one of the plurality of presence lists corresponding to the category of service and including at least one service provider presence record indicating that the respective service provider corresponding to the at least one service provider presence record is presently available;
receiving, at the server, for each of the at least one service provider presence records, periodic location updates for the respective service provider;
receiving, at the server, a service request from a user including an indication of a category of service being requested;
the server identifying one of the plurality of presence lists corresponding to the category of service being requested, and comparing a user location of the user with the locations of each of at least one service provider presence record in the one of the plurality of presence lists and identifying a candidate service provider; and
initiating a communication between the candidate service provider and the user.

7. The method of claim 6, wherein initiating communication between the candidate service provider and the user comprises transmitting to the candidate service provider the contact information of the user.

8. The method of claim 6, wherein initiating communication between the candidate service provider and the user comprises initiating a call between the candidate service provider and the user.

9. The method of claim 6, further comprising:
after identifying the candidate service provider, the server transmits a message to the user including information about the candidate service provider; and
the server receiving confirmation from the user to proceed.

10. The method of claim 6, wherein identifying the candidate service provider comprises:
identifying a plurality of candidate service providers; and
receiving a selection of one of the plurality of candidates from the user.

11. A system for matching a service request with a service provider, comprising:
a server having a processor;
the processor executes instruction code that causes the processor to:
maintain, at the server, for each of a plurality of service providers, a respective service provider record, the service provider record indicates, for the corresponding service provider, a category of service provided and contact information for the service provider, a service location that defines a geographic region, and a present availability;
maintain, at the server, a plurality of presence lists, each one of the plurality of presence lists that corresponds to the category of service and includes at least one service provider presence record that indicates that the respective service provider corresponding to the at least one service provider presence record is presently available;
receive, at the server, for each of the at least one service provider presence records, periodic location updates for the respective service provider;
receive, at the server, a service request from a user including an indication of a category of service being requested;
identify, by the server, one of the plurality of presence lists corresponding to the category of service being requested, and comparing a user location of the user with the locations of each of at least one service provider presence record in the one of the plurality of presence lists and identifying a candidate service provider; and
initiate a communication between the candidate service provider and the user.

12. The system of claim 11, wherein the server, to initiate communication between the candidate service provider and the user, transmits to the candidate service provider the contact information of the user.

13. The system of claim 11, wherein the server, to initiate communication between the candidate service provider and the user, initiates a call between the candidate service provider and the user.

14. The system of claim 11, wherein the processor further:
response to identifying the candidate service provider, transmits a message to the user including information about the candidate service provider; and
the server receives confirmation from the user to proceed.

15. The system of claim 11, wherein the processor, in identifying the candidate service provider, identifies a plurality of candidate service providers, and receives a selection of one of the plurality of candidates from the user.
